(19) United States
(12) Patent Application Publication
(10) Pub. No.: US 2007/0241037 A1
(43) Pub. Date: Oct. 18, 2007

(54) Water purifier

(76) Inventor: Wei-jen Wang, Tai-shan Hsiang (TW)

Correspondence Address: LADAS & PARRY, 5670 WILSHIRE BOULEVARD, SUITE 2100, LOS ANGELES, CA, 90036-5679, US

(21) Appl. No.: 11/726,846

(22) Filed: Mar. 23, 2007

(30) Foreign Application Priority Data
Mar. 27, 2006 (TW) 095110494

(51) Int. Cl. B01D 35/14

(52) U.S. Cl. 210/94; 210/143; 210/223; 210/259; 210/456; 210/501; 210/506

(57) ABSTRACT

A water purifier under the present invention comprises a filtering pot, a purifying pot, a sterilizing pot, and related connecting pipes, as well as a control circuit. The filtering pot filters iron rust, mud pigment, floating particles, and so forth. The purifying pot removes odor, chloride, pesticide residuals, chemicals, and so forth. The sterilizing pot mineralizes the water, sterilizes bacteria and virus, delicates the water molecule, and co-operates with the control circuit, to provide a water purifier with high bactericidal and viral elimination rate and self-monitoring and energy saving functions.

### CROSS-REFERENCE TO RELATED APPLICATION

This application claims the priority of Taiwanese patent application no. 095110494 for “Water Purifier” filed on Mar. 27, 2006.

### BACKGROUND

This invention relates to a water purifier, and the purpose is to provide a high sterilizing rate, self-monitoring and energy-saving water purifier structure.

The water percentage in the human body is more than sixty percent, and water's main function is to transport nutrients and essential chemical substances into and out of the cells; thus water can maintain the skin moist, keep the brain working properly, adjust the body temperature effectively, and help to delay aging. The significance of water to the human body is beyond imagination.

Water source pollution resulting from industrial development, the age of pipe lines in water distribution systems, and the ill-maintenance of water-storage facilities, cause drinking water to be exposed to potential organic or inorganic contaminants. Consequently, people have doubts and concern about the safety of their drinking water. Even after water treatment in a water purifying plant, the water flowing out of faucets may contain heavy metals from within the pipe line and pesticides or germs from nearby ground may flow into the water source. These floating particles or contaminants may invade directly into your body through the water you drink. Therefore, it is a trend to improve the water quality by using water purifiers in order to protect the safety and health of user and one's family.

Currently, most conventional water purifiers on the market are passive filtering apparatuses. They merely employ filters to filter out and remove the impurities, particles and contaminants present in the water. Not only can they not sterilize water completely, but also they can not improve the water quality. Although some water purifiers have installed UV lamps for sterilization, the UV lamps of ordinary water purifiers are on constantly. This wastes the electricity energy and increases the water temperature (the water temperature of the initial output water of the typical UV lamp sterilizer is about 60-70° C.). These water purifiers are unable to allow users to drink room-temperature clean water from the initial flow.

### SUMMARY

A filtering pot, a purifying pot, a sterilizing pot, connection pipes, and a control circuit are integrated into a high sterilizing, self-monitoring and power saving water purifier structure.

The filtering pot includes an inlet and an outlet, is constructed with high density water softening filtering cotton for filtering the iron rust, mud pigment, and solid floating particles in the water. The purifying pot includes an outlet and an inlet constructed with silver ion anti-bacterial active carbon for removing odor, chloride, pesticide residual or chemical elements, and generates silver oxide ion in water to suppress bacteria breeding. The sterilizing pot includes an outlet and an inlet, is constructed with a condensed carbonized healthy stone, a UV sterilizing lamp, a far infrared magnetic hose for mineralizing the water, sterilizing and filtering out virus, and fining the water molecules. Each connection pipe continues among each filtering pot to construct a complete water-purifying process, and to maintain the whole water purifier proper operation under the monitor of the control circuit.

Especially, the control circuit intermittently turns on the UV lamp for a period of time, and turns on the UV sterilizing lamp all the time during water utilization, and adjusts the intensity of radiation of UV depending on the amount of water flux for saving energy and to ensure the water in the filtering pot is bacterial free.

### BRIEF DESCRIPTION OF THE DRAWINGS

FIG. 1 is a perspective view of an embodiment of a water purifier of the present invention.

FIG. 2 is a perspective view of the back and top sides of the water purifier of FIG. 1, with the upper cover removed.

FIG. 3 is a perspective view of the back and bottom sides of the water purifier of FIG. 1, with the housing generally removed.

FIG. 4 is a perspective view of the side and bottom side of the water purifier of FIG. 1, with the housing generally removed.

FIG. 5 is a perspective view of a filtering pot of the water purifier of FIG. 1.

FIG. 6 is a perspective view of a purifying pot of the water purifier of FIG. 1.

FIG. 7 is a perspective view of a sterilizing pot of the water purifier of FIG. 1.

### DESCRIPTION OF THE NUMBERS OF THE MAIN COMPONENTS OF THE PREFERRED EMBODIMENT

10 housing
11 mechanical frame
12 upper cover
13 inlet
14 outlet
15 power plug
20 filtering pot
21 filtering cotton
22 spiral base
221 inlet
222 outlet
23 spiral cover
30 purifying pot
31 silver ion antibacterial active carbon
32 pot
321 inlet
322 outlet
33 spiral cover
40 sterilizing pot
41 pot
411 top base
412 spiral cover
413 inlet
414 outlet
415 tube
42 magnetizing unit
421 condensed carbonized healthy stone
422 far infrared magnetic hose
43 UV (ultraviolet) sterilizing lamp
50 control circuit
51 digital electronic flux meter

### DESCRIPTION OF SPECIFIC EMBODIMENT

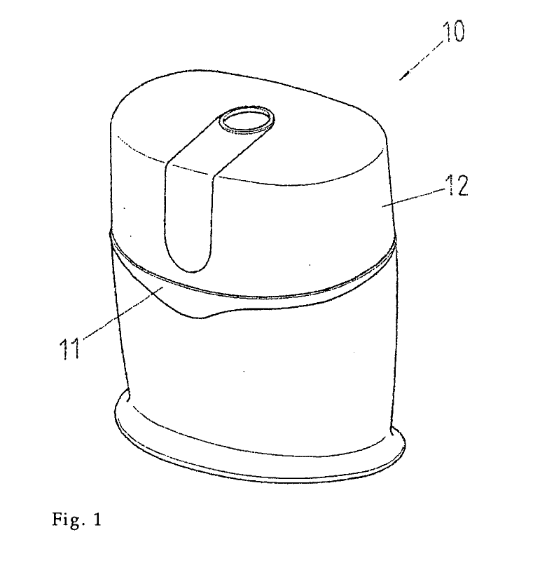

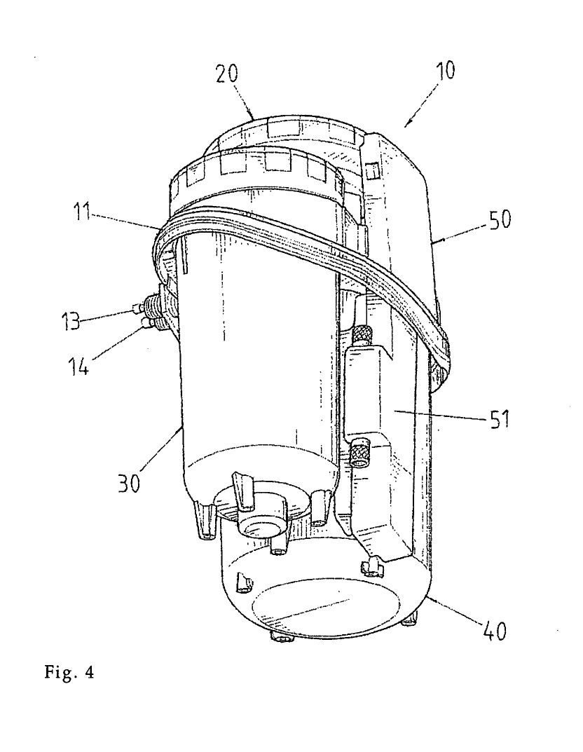

The basic construction of a structure of a preferred embodiment of the water purifier of the present invention is shown in FIG. 1 to FIG. 4. The water purifier comprises a housing 10, a filtering pot 20, a purifying pot 30, a sterilizing pot 40, connecting pipes, and a control circuit 50. The housing 10 is employed for receiving and accommodating the related components, the housing 10 includes a mechanical frame 11 as main structure and has an upper cover 12 for easy opening, an inlet 13, an outlet 14 and power plug 15 are set in the mechanical frame 11 of the housing 10. The housing 10 is not only for enhancing the structural completeness, but also convenient when replacing filtering pots. It is connected to water supply pipe lines through an inlet 13, and the sterilized processed water is connected to related outlet facilities through an outlet 14. This becomes a high efficiency anti-bacteria water purifier.

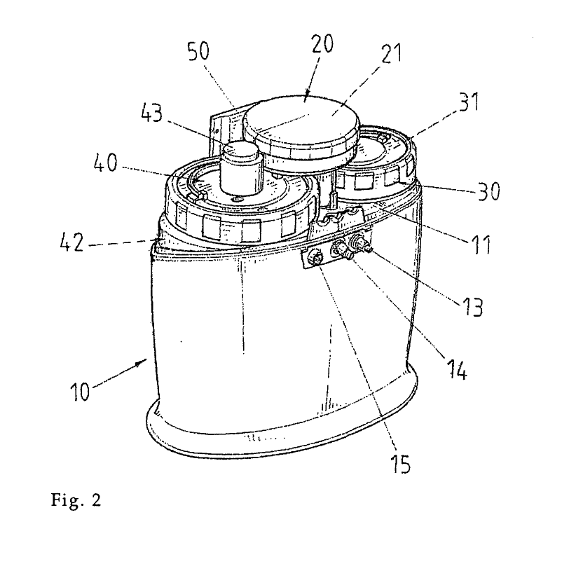

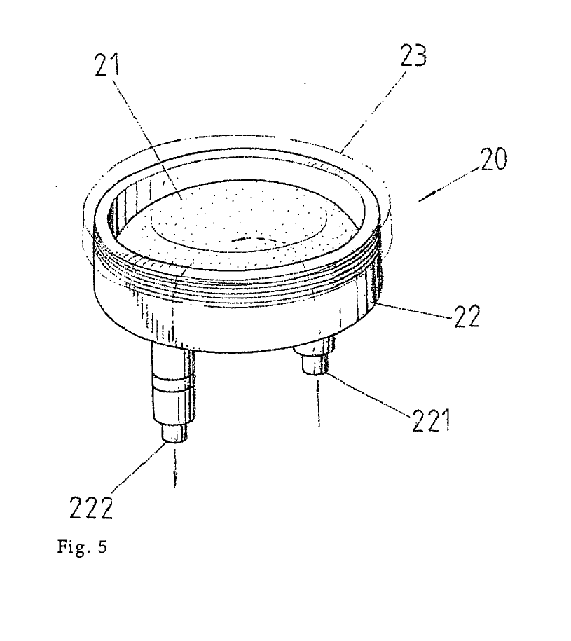

As shown in FIG. 2 and FIG. 5, the filtering pot 20 is constructed with filtering cotton 21, which is a high density water softening filtering cotton for filtering iron rust, mud pigment, and solid floating particles in the water. The filtering cotton 21 has properties of easy cleaning and reusability. For purposes of embodiment, the filtering cotton 21 is contained inside a spiral base 22 with an inlet 221 and an outlet 222, and covered by a spiral cover 23 to limit the water to flow through the filtering cotton 21, thereby achieving the effect of removing the iron rust, mud pigment, and solid floating particles in the water.

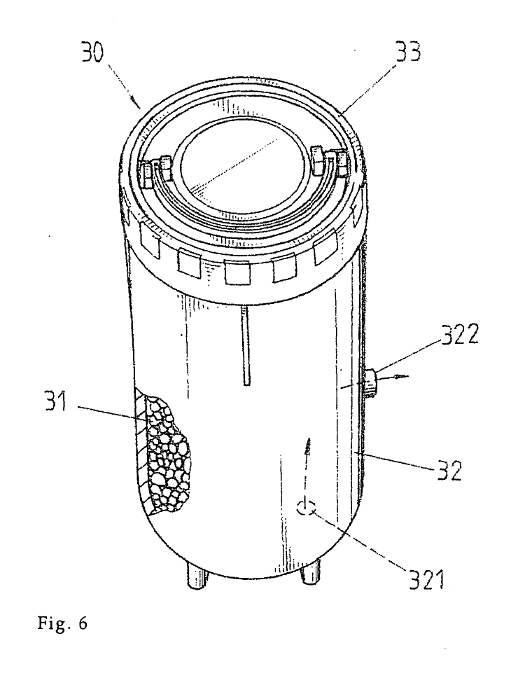

As shown in FIG. 2 and FIG. 6, the purifying pot 30 is constructed with silver ion antibacterial active carbon 31. The silver ion antibacterial active carbon 31 is contained within a pot 32 with an inlet 321 and an outlet 322. A spiral cover 33 seals the top opening of the pot 32 to limit the water flowing through silver ion antibacterial active carbon 31 for achieving the purposes of removing odor, chloride, pesticide residuals, and chemical elements in the water. It also generates silver oxide ions in the water to suppress the propagation of bacteria and thereby clean the water.

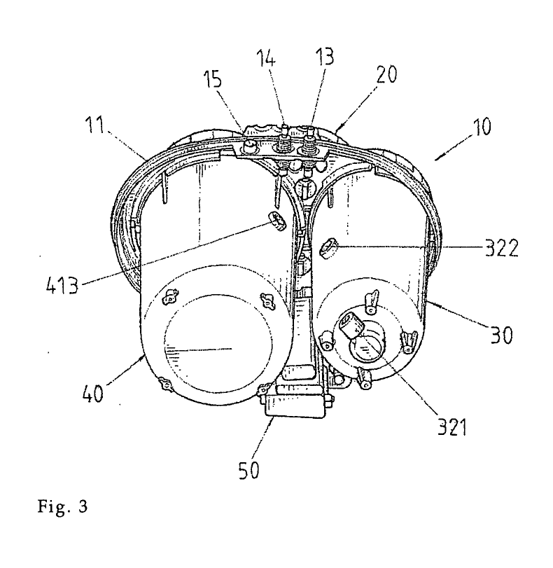

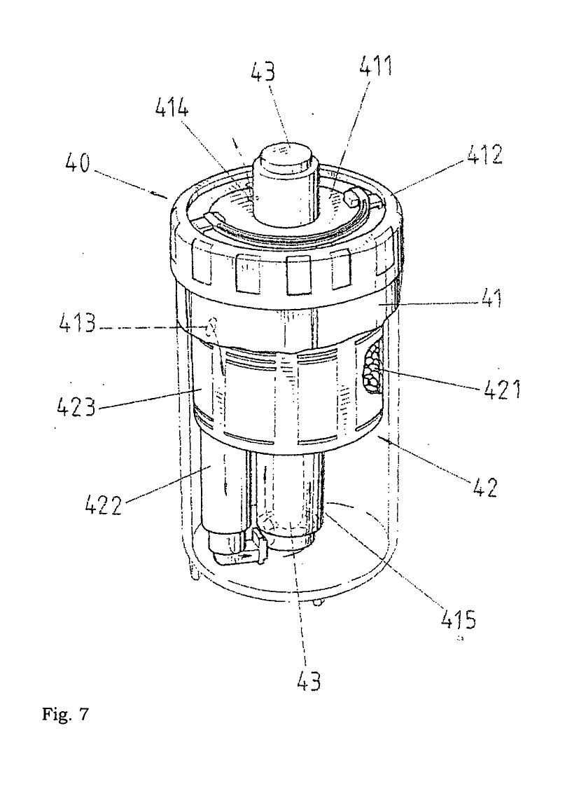

Furthermore, as shown in FIG. 3 and FIG. 7, the sterilizing pot 40 comprises a pot 41 having an outlet 414 and an inlet 413 to contain a magnetizing unit 42, and a UV (ultraviolet) sterilizing lamp 43. The magnetizing unit 42 further comprises a condensed carbonized healthy stone 421 and far infrared magnetic hose 422, the condensed carbonized healthy stone 421 is employed for mineralizing the water, and the water molecules are finer under the function of the far infrared magnetic hose 422. An embodiment of a suitable sterilizing pot is described in my co-pending U.S. application for a “Sterilizing Pot for a Water Purifier,” incorporated herein by reference, which application claims the priority of Taiwanese patent application no. 095205061 for “The Sterilizing Pot for the Water Purifier” filed on Mar. 27, 2006.

A top base 411 and a spiral cover 412 are set on the top opening of the pot 41, and the spiral cover 412 presses the top base 411 on the opening on top of the pot. An inlet 413 is set up on the side portion of the pot 41, an outlet 414 is set up on the top base 411. The condensed carbonized healthy stone 421 of the magnetizing unit 42 is set up in the area corresponding to the inlet 413 through an assembling case 423. A tube 415 is set up in the center portion of the top base 411 and passes through the assembling case 423 and extends downward. The UV lamp 43 is set up within the tube 415, the far infrared magnetic hose 422 of the magnetizing unit 42 is in beehive-shape, and is connected between the bottom of the assembling case 423 and the tube 415.

The water flowing through the inlet 413 and into the pot 41 first flows into the assembling case 423, and infiltrates downward through the condensed carbonized healthy stone 421 and passes through the far infrared magnetic hose 422 into the tube 415 and upward into the top base 411, and finally drained out of the pot 41 through the outlet 414. Therefore, the water can be totally under the function of the magnetizing unit 42 and the UV lamp 43. The condensed carbon healthy stone 421 releases more than thirty essential minerals required by human body to achieve the purpose of water mineralization, and those minerals belong to ionized minerals which are absorbed most easily by the human body, and it can turn acid water into slightly alkaline water suitable for human body. It neutralizes/washes the acid toxins in the human body through mineral-containing slightly alkaline water. The bacteria in the water are killed by the UV lamp 43, and more than 99% of viruses are filtered out to ensure the water purifier releases bacterial-free and virus-free clean water.

The above filtering pot 20, purifying pot 30, and sterilizing pot 40 are connected one after one and form a complete water-purifying process, and maintain proper operation of the whole water purifier under the monitor of the control circuits 50. In practical applications, the control circuit 50 intermittently turns on the UV lamp for a period of time (for example, the UV lamp 20 will be automatically turned on to kill the bacteria after three hours off). The UV lamp is turned on at all times during the water utilization. A digital electronic flux meter 51 is set up not only to compute the water amount in a single usage, but also accumulates the water usage amount to show and reflect the remaining life time of the filtering pot 20, and further calculate the actual water flux to allow the control circuit 50 adjust the radiation intensity of the UV lamp according to the water flux so as to save energy and to ensure the water in the sterilizing pot 40 is bacterial free.

Certainly, a display can be further configured to connect to the control circuit 50 to display the operation status of the water purifier and the related water usage record of the water purifier. In one embodiment, the display can be designed as a LCD display with related icons. And the control circuit 50 and related sensors examine the whole working status of the water purifier and then display the status by light, icons, sounds or issue inoperative warning. Therefore, based on the related status indication, the user can operate the water purifier easily, ensure the operation safety, and maintain the water purifier in best working conditions.

As described above, a preferable water purifier structure is disclosed. However, the above description and the drawings are of a preferred embodiment of the present invention, and not for purposes of limiting the invention. Therefore, all structures, devices and features similar to the present invention all belong to the invention as defined by the scope of the appended claims.

I claim:

1. A water purifier comprising:
a housing for containing associated components of said water purifier;
a filtering pot including an outlet and an inlet within said water purifier for filtering out rust, mud pigment or floating particles in water;
a purifying pot including an outlet and an inlet for removing odor, chloride, pesticide residuals or chemical elements;
a sterilizing pot including an outlet and an inlet for mineralizing said water, sterilizing bacteria, and virus;
a connecting pipe connected among each sterilizing pot to construct a complete water cleaning system; and
a control circuit for monitoring the operation of said water purifier.

2. The water purifier of claim 1, wherein said housing comprises a main frame including an inlet and outlet and an upper cover for easy opening.

3. The water purifier of claim 1, wherein said housing further comprises a display connected to said control circuit.

4. The water purifier of claim 3, wherein said display is a LCD display and controlled by said control circuit and sensors are provided for cooperation with said control circuit to examine the operation status of said water purifier and to show the status of said water purifier by lighting, icons, sound and issue a failure warning.

5. The water purifier of claim 1, wherein said filtering pot further comprises a filtering cotton placed within a spiral base with said inlet and said outlet, and said filtering pot is sealed by a spiral cover.

6. The water purifier of claim 5, wherein said filtering cotton is a high density water softening filter cotton.

7. The water purifier of claim 1, wherein said purifying pot is comprises a silver ion anti-bacteria active carbon.

8. The water purifier of claim 7, wherein said silver ion anti-bacteria active carbon is contained within a bottle with an inlet and outlet, wherein a spiral cover seals on the top opening of said bottle.

9. The water purifier of claim 1, wherein said sterilizing pot further comprises:
a pot configured with said inlet and said outlet for accommodating associated components as a mechanical main body;
a magnetizing unit configured within said pot for mineralizing said water and fining the water molecules; and
a UV lamp configured within said pot for sterilizing bacteria or virus in said water.

10. The sterilizing filtering pot of claim 9, wherein said magnetizing unit comprises a condensed carbonized healthy stone and a far infrared magnet hose.

11. The sterilizing pot of claim 9, further comprising a top base at the opening on the top of said pot, and a spiral cover for sealing said top base, said inlet is set on the side portion of said pot, and said outlet is set on the top base, wherein said condensed carbon healthy stone of said magnetizing unit is assembled in the area corresponding to the inlet; a tube passes through a case and extends downward, said UV lamp being configured within said tube, said far infrared hose of said magnetic unit being connected between the bottom of said case and said tube.

12. The sterilizing pot of claim 10, wherein said far infrared magnetic hose is in a bee-hive shape.

13. The sterilizing pot of claim 11, wherein said far infrared magnetic hose is in a bee-hive shape.

14. The water purifier of claim 1, wherein said control circuit includes a digital flux meter for calculating the single usage of water and accumulative usage of water and to calculate the actual water flux.

15. The water purifier of claim 13, wherein said control circuit intermittently turns on said UV lamp under normal conditions for a period of time, wherein said UV lamp is on during supplying water and the radiation intensity of UV ray is adjusted depending on said water flux.
